(19) United States
(12) Patent Application Publication
(10) Pub. No.: US 2011/0275360 A1
(43) Pub. Date: Nov. 10, 2011

(54) PRIVACY GATEWAY

(75) Inventors: Duncan Russell Christopher Charles Edward Sample, Huntingdon (GB); Carlos Manzanares Sancho, Tampere (FI); Konrad Daniel Garlikowski, Wroclaw (PL); Mikhael Harswanto, Jakarta (ID); Irving Benjamin Cordova, Bogota (CO); Caio Bottiglieri, Sao Paulo (BR)

(73) Assignee: NOKIA SIEMENS NETWORKS OY, Espoo (FI)

(21) Appl. No.: 12/776,910

(22) Filed: May 10, 2010

(51) Int. Cl. H04W 4/00

(52) U.S. Cl. 455/422.1

(57) ABSTRACT

The present invention relates to methods and apparatus for maintaining the privacy of a user 103, 105 and/or user's mobile device 104, 106 when communicating with an application 109, 110. Communications between a mobile device 104 of a user 103 and an application 109 are controlled wherein the mobile device 104 is identified by a first identifier for communications between a gateway 102 and the mobile device 104 and the mobile device 104 is identified by a second identifier for communications between the gateway 102 and the application 109. The methods and apparatus translate between the first identifier and the second identifier, and determine whether the communications between the mobile device 104 and the application 109 are enabled or disabled.

The present invention relates to a privacy gateway and, in particular, a privacy gateway between a mobile device and an application.

Presently, a user via a mobile device may use services, typically implemented by applications, provided by third parties, such as service providers, mobile operators, and so on. The user may communicate with the service in order to transmit data to the service and to receive data from the service. Therefore, in order to use the service the application implementing the service must recognise the user, in particular the user's mobile device, and as such the service will require details of the user and/or the user's mobile device. Thus, the user has to decide whether or not to trust the service and, if the user has registered for or subscribed to a service then they may not be able to prevent the service from communicating with them.

If the services require data from a mobile operator about a user and/or the user's mobile device, for example, to obtain location data for the user's mobile device, then the service, and the application implementing the service, needs to be trusted by the mobile operator. If the service is not trusted then the mobile operator will not supply data to the service about a user and/or user's mobile device. Therefore, the service needs to be trusted by the mobile operator so as to fall within the trusted telecommunication domain or be developed by or on behalf of the mobile operator. This therefore prevents many independent developers of services and applications to develop and publish those services for use by users. Also, the developers of the services and applications will require detailed telecommunication knowledge in order to be able to implement those services and applications to interact with the mobile operators.

Cloud Computing is a paradigm that moves resources, services and applications into a cloud enabling users to access and utilise the resources, services and applications. The cloud may refer to delivering resources, services and applications over the Internet which are sold/used on demand and provides substantial flexibility. More services and applications are moving into the cloud which is an open market which is not necessarily trusted by the users and/or the mobile operators.

Thus, there is a need to increase privacy for users of services which are moving to the cloud. There is also a need to enable the services in the cloud to obtain data from mobile operators in the telecommunication domain where those services may not be within the trusted zone of the mobile operators. The embodiments of the present invention may address one or more of the needs.

According to a first aspect of the present invention there is provided a method for operating a gateway comprising: receiving communications from a mobile device of a user; receiving communications from an application; controlling communications between a mobile device of a user and an application wherein the mobile device is identified by a first identifier for communications between the gateway and the mobile device and the mobile device is identified by a second identifier for communications between the gateway and the application; translating between the first identifier and the second identifier; and determining whether the communications between the mobile device and the application are enabled or disabled.

The method may implement, operate or provide the functionality for a privacy gateway. The communications between a mobile device and an application are controlled by using a first identifier for communication between the gateway and the mobile device and using a second identifier for communication between the gateway and the application. The first identifier may be an identifier of the mobile device which is used to address or communicate with the mobile device, for example, the Mobile Subscriber Integrated Services Digital Network Number (MSISDN), the International Mobile Subscriber Identity (IMSI), and so on. The second identifier may be a unique identifier that may be generated by the gateway but is different to the first identifier. Therefore, the method may further comprise generating a second identifier for each first identifier of the mobile device.

The method translates between the first and second identifiers so that the application may not receive an identifier of the mobile device that enables the application to identify the real mobile device thereby preventing the application from communicating directly with the mobile device. The method may also determine whether communications between the mobile device and the application are enabled or disabled. Thus, the privacy of the mobile device and the user of the mobile device is maintained by the gateway.

The translation between the first identifier and the second identifier may occur prior to or after the determination as to whether the communication is enabled or disabled. The translation may include performing a search for the first identifier in a database and retrieving the second identifier corresponding to the first identifier. The database may be part of the gateway or may be operatively connected thereto.

The communications may be any communication between the mobile device and the application, for example, Short Message Service (SMS) messages, Multimedia Message Service (MMS), and so on. The mobile device may be any device that is able to transmit and receive communication, for example, a mobile telephone, The application may be any application that provides services, resources, information, and so on, to the user and the application may be published (e.g. implemented or located) in the so called cloud of cloud computing.

The method may further comprise transmitting the communications to the mobile device or to the application if the communications between the mobile device and the application are enabled. Thus, only if the communications is enabled will the communication be transmitted to the mobile device or the application.

The method may further comprise receiving user control settings relating to the mobile device; storing the user control settings relating to the mobile device; and wherein the step of determining whether the communications are enabled or disabled is based on the user control settings. Therefore, the user of the mobile device may supply or provide user control settings where the control settings may be used to determine whether or not communications are enabled or disabled. The received user control settings may be stored per mobile device. The user control settings may, for example, specify whether an application is blocked by the user. The user control settings may include any settings that may be used to determine if communications are enabled or disabled. The user control settings may be stored in the database connected to, or part of, the entry in the database for the first identifier.

The method may further comprise receiving operator control settings relating to a mobile operator; storing the operator control settings relating to the mobile operator; and wherein the step of determining whether the communications are enabled or disabled is based on the mobile operator control settings. Therefore, the mobile operator may supply or provide operator control settings where the control settings may be used to determine whether or not communications are enabled or disabled. The received operator control settings may be stored in the database. The operator control settings may, for example, specify whether an application is allowed or permitted to use the mobile operator's assets, for example, the mobile operator's network. The operator control settings may include any settings that may be used to determine if communications are enabled or disabled.

The method may further comprise receiving communications from a mobile operator; controlling communications between the application and the mobile operator wherein the mobile device is identified by the first identifier for communications between the gateway and the mobile operator; and determining whether the communications between the application and the mobile operator are enabled or disabled. Therefore, if the application requires information, data or resources from the mobile operator then the first identifier is used to identify the mobile device to the mobile operator.

According to a second aspect of the present invention there is provided a gateway comprising: a first input adapted to receive communication from a mobile device of a user; a first output adapted to transmit communication to the mobile device of the user; a second input adapted to receive communication from an application; a second output adapted to transmit communication to the application; a first processor adapted to control communications between the mobile device and the application wherein the mobile device is identified by a first identifier for communications between the gateway and the mobile device and the mobile device is identified by a second identifier for communications between the gateway and the application; a second processor adapted to translate between the first identifier and the second identifier on request of the first processor; and a third processor adapted to determine whether the communications between the mobile device and the application are enabled or disabled on request of the first processor.

According to a third aspect of the present invention there is provided a gateway adapted to: receive communications from a mobile device of a user; receive communications from an application; control communications between a mobile device of a user and an application wherein the mobile device is identified by a first identifier for communications between the gateway and the mobile device and the mobile device is identified by a second identifier for communications between the gateway and the application; translate between the first identifier and the second identifier; and determine whether the communications between the mobile device and the application are enabled or disabled.

The first processor may be further adapted to initiate transmission of the communications to the mobile device or to the application if the third processor determines the communications between the mobile device and the application are enabled.

The gateway may further comprise a third input adapted to receive user control settings relating to the mobile device; a fourth processor adapted to store the user control settings relating to the mobile device; and wherein the third processor is further adapted to determine whether the communications are enabled or disabled based on the stored user control settings.

The gateway may further comprise a fourth input adapted to receive mobile operator control settings relating to a mobile operator; a fifth processor adapted to store the mobile operator control settings relating to the mobile operator; and wherein the third processor is further adapted to determine whether the communications are enabled or disabled based on the stored mobile operator control settings.

The gateway may further comprise a fifth input adapted to receive communication from a mobile operator; a third output adapted to transmit communication to the mobile operator; wherein the first processor is further adapted to control communications between the application and the mobile operator wherein the mobile device is identified by the first identifier for communications between the gateway and the mobile operator; and wherein the third processor is further adapted to determine whether the communications between the application and the mobile operator are enabled or disabled on request of the first processor.

The first input, second input, third input, fourth input and fifth input may be the same input, different inputs or any combination thereof. The first output, second output and third output may be the same output, different outputs or any combination thereof. The first processor, second processor, third processor, fourth processor and fifth processor may be the same processor, different processors or any combination thereof.

As a skilled person in the art will appreciate, the gateway may be adapted to perform the functions or features in many different ways. For example, the gateway may be adapted by software, hardware or any combination thereof.

According to a fourth aspect of the present invention there is provided a computer program product comprising computer readable executable code for: receiving communications from a mobile device of a user; receiving communications from an application; controlling communications between a mobile device of a user and an application wherein the mobile device is identified by a first identifier for communications between the gateway and the mobile device and the mobile device is identified by a second identifier for communications between the gateway and the application; translating between the first identifier and the second identifier; and determining whether the communications between the mobile device and the application are enabled or disabled.

The computer program product may further comprise computer readable executable code for performing any or all of the functions or features in accordance with the aspects of the invention.

Preferred embodiments of the present invention will now be described, by way of example only, and with reference to the accompanying drawing in which:

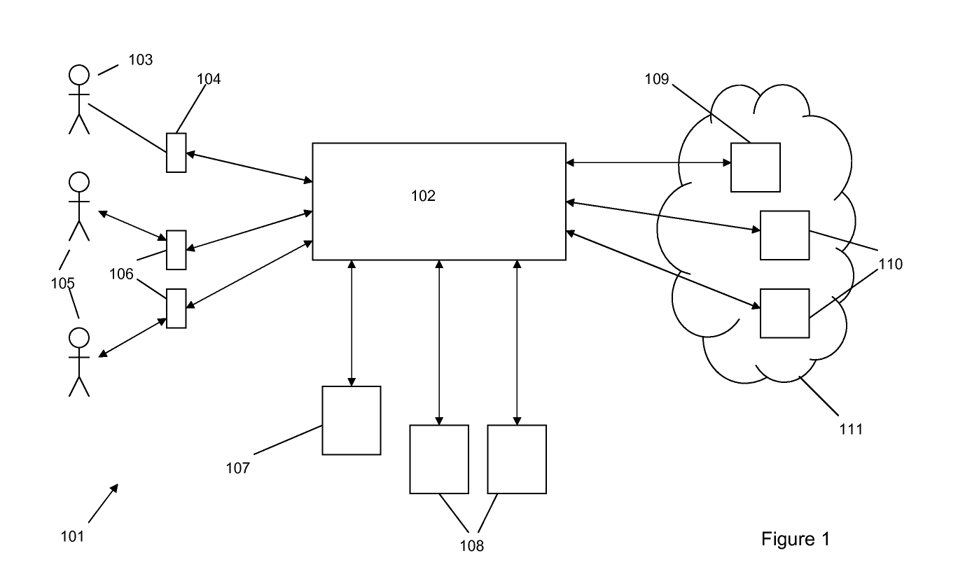

FIG. 1 shows a simplified block diagram of a system according to many of the embodiments of the present invention.

FIG. 1 shows a block diagram of a system 101 which includes users 103, 105 each with a mobile device 104, 106 that may operatively communicate with a privacy gateway 102. The privacy gateway 102 may also operatively connected to mobile operators 107, 108 and also operatively connected to applications 109, 110.

The mobile device 104, 106 may be any mobile device, for example, a mobile telephone, that may transmit and receive messages and data to and from a mobile access network. The mobile access network is not shown in FIG. 1 as it is well known in the art.

The privacy gateway 102 may be implemented as a separate apparatus, e.g. computing device, server, and so on. The privacy gateway 102 may be implemented as functionality on an apparatus in the telecommunication network, for example, a Mobile Switching Centre (MSC). The privacy gateway 102 may be implemented or located in the cloud 111 and offered as a service or platform.

The applications 109, 110 may be implemented or located in the cloud 111 which is effectively an open marketplace for applications and therefore are separate to the telecommunication domain. The applications may provide any service or information that the user may wish to request or to receive.

The mobile operators 107, 108 are located in the traditional telecommunication domain and provide the user 103, 105 with telecommunication services where each user 103, 105 will be subscribed to a mobile operator 107, 108.

The privacy gateway 102 will be trusted by the mobile operators 107, 108 and thus is able to obtain any necessary data or information from the mobile operators 107, 108 relating to the users 103, 105 and/or their mobile devices 104, 106.

The user's 103, 105 may register or subscribe to the privacy gateway 102 in order to utilise the applications 109, 110 and to utilise the functionality of the privacy gateway 102. If the user 103, 105 registers with the privacy gateway 102 then the user 103, 105 may provide the privacy gateway 102 with the Mobile Subscriber Integrated Services Digital Network Number (MSISDN) of the user's mobile device 104, 106. However, the user 103, 105 may not need to register with the privacy gateway 102 in order to utilise the functionality provided by the privacy gateway 102. Thus, if the user 103, 105 does not register with the privacy gateway 102 before using or accessing a service provided by an application 109, 110 then when the user 103 via mobile device 104 transmits a message to application 109 then the privacy gateway 102 may receive the MSISDN of the mobile device 104.

The privacy gateway 102 may also receive user control settings from each user 103, 105 where the user control settings may include settings relating to privacy in order to define whether communication with the applications 109, 110 are enabled or disabled. The user 103, 105 may provide or update any of the user control settings at any time via their mobile device 104, 106 or via a computing device such as a laptop. This increases the user's 103, 105 trust and privacy when interacting or using application 109, 110 in the cloud 111.

The applications 109, 110 may be registered with the privacy gateway 102 so that they can receive and transmit data and/or messages to the mobile operators 107, 108 and the mobile devices 104, 106 of the users 103, 105. The developer or provider of the application 109, 110 may register the application 109, 110 by communicating with the privacy gateway 102 in order to publish the application 109, 110 in the cloud 111.

The privacy gateway 102 may control the communications between mobile devices 104, 106 and the application 109, 110 registered with the privacy gateway 102. The privacy gateway 102 may also control the communications between the applications 109, 110 and the mobile operators 107, 108. The communication may be controlled such that the privacy and security of the user 103, 105 can be maintained in all communications with the applications 109, 110.

Therefore, the privacy gateway 102 has inputs/outputs for receiving/transmitting communication to the mobile devices 104, 106, the mobile operators 107, 108 and the applications 109, 110.

The privacy gateway 102 may include a database that may include an entry for each mobile device 104, 106. The entry for each mobile device 104, 106 may include a first identifier, for example, the MSISDN of the mobile device 104, 106 and a corresponding second identifier. The first identifier will be unique and used for communication to the mobile device 104, 106, for example, the first identifier may be the MSISDN of the mobile device 104, 106. The second identifier will also be unique and be generated by the privacy gateway 102. The second identifier may be used by the privacy gateway 102 to identify the mobile device 104, 106 when communicating with the applications 109, 110. The first identifier and the second identifier are different identifiers used to identify the mobile device 104, 106 so that the applications 109, 110 are unable to determine the contact details for the mobile device 104, 106 thereby preventing the applications 109, 110 from communicating directly with the mobile device 104, 106.

The entry for each mobile device 104, 106 in the database of the privacy gateway 102 may also include user control settings for the user 103, 105 of the mobile device 104, 106 which may be defined by the user 103, 105 at any time. For example, the user 103, 105 may at any time provide user control settings that define whether a particular application 109, 110 may communicate with the user 103, 105. Thus, after a user 103, 105 has accessed, subscribed to or used an application 109, 110 the user 103, 105 may decide to no longer use the application 109, 110. The user 103, 105 may modify the user control settings to block the application 109, 110 without needing to interact or deal directly with the application 109, 110.

Mobile operators 107, 108 may also provide operator control settings which may specify or define whether, for example, an application 109, 110 is enabled or disabled from using the mobile operator's 107, 108 assets, for example, the mobile network of the mobile operator 107, 108. The operator control settings may also be stored in the database of the privacy gateway 102.

Considering firstly the communication between the mobile device 104 of user 103 and the application 109 where the first identifier is the MSISDN of the mobile device 104. The user 103 will have a mobile service subscription with mobile operator 107 in order to transmit/receive communication to/from their mobile device 104.

The communication message (e.g. Short Message Service (SMS) message, Multimedia Message Service (MMS) message, and so on) transmitted from the mobile device 104 may either be addressed to the privacy gateway 102 where the message identifies that it is destined for the application 109, or the communication message may be addressed to the application 109 but intercepted, monitored or received by the privacy gateway 102. For example, the privacy gateway 102 may monitor for any communication messages addressed to an application registered with the privacy gateway 102.

The privacy gateway 102 on receipt of the communication message may proceed to control the communication between the mobile device 104 and the application 109 to ensure that the privacy and security of the user 103 is maintained. The privacy gateway 102 may identify the MSISDN of the mobile device 104 and may identify the application 109 from the received communication message. The privacy gateway 102 translates between the MSISDN and the corresponding second identifier which is used to identify the mobile device 104 to the application 109. To translate from the first identifier to the second identifier the privacy gateway 102 may locate an entry in the database for the first identifier in order to determine or retrieve the corresponding second identifier for the mobile device 104. Similarly, to translate between the second identifier and the first identifier the privacy gateway 102 may locate an entry in the database for the second identifier in order to determine or retrieve the corresponding first identifier for the mobile device 104.

As described hereinabove, the user 103 of the mobile device 104 may inform the privacy gateway 102 of their user control settings. For example, the user 103 may inform the privacy gateway 102, via the appropriate user control settings, that a particular application is to be blocked from communicating with the user 103. Furthermore, the mobile operator 107 may set operator control settings, for example, the mobile operator 107 may specify that a particular application may be blocked from using the assets of the mobile operator 107, blocked from being accessed or used by a user 103 (e.g. subscriber) of the mobile operator 107, blocked from obtaining data or information relating to the user 103 from the mobile operator 107, and so on.

Thus, the privacy gateway 102 may further determine whether communications between the mobile device 104 of the user 103 and the application 109 is enabled or disabled based on the user control settings and the operator control settings. If the communication is enabled, and no further information or data is required from the mobile operator 107 of the user 103, then the communication message is transmitted from the privacy gateway 102 to the application 109 where the second unique identifier is used to identify the mobile device 104 to the application 109. If the communication is disabled based on either or both of the user control settings and the operator control settings then the privacy gateway 102 does not transmit, or prevents the transmission of, the communication message to the application 109.

If the privacy gateway 102 determines that information or data is required from the mobile operator 107 of the user 103 then the privacy gateway 102 may transmit a request message to the mobile operator 107 for the necessary information or data. For example, the privacy gateway 102 may identify or determine that location data for the mobile device 104 of the user 103 is necessary for the application 109 to provide the service that the user 103 wishes to use.

The privacy gateway 102 may identify the relevant mobile operator 107 from the communication message received from the mobile device 104 of the user 103. The privacy gateway 102 may identify the relevant mobile operator 107 from the user control settings that the user 103 may have supplied to the privacy gateway 102.

The privacy gateway 102 may communicate with the mobile operator 107 using the first identifier, e.g. the MSISDN, so that the mobile operator 107 can identify the mobile device 104 of the user 103 and provide the requested information or data. The mobile operator 107 may respond to the privacy gateway 102, using the first identifier, e.g. the MSISDN. The privacy gateway 102 may then include the received information or data into a communication message, either the same communication message that was received or a different communication message. If communication between the mobile device 104 and the application 109 is enabled then the information or data received from the mobile operator 107 may be transmitted to the application 109 along with the original communication message.

For example, a user 103 may wish to find pizza delivery companies in the local area of the user 103. The user 103, via their mobile device 104, may transmit an SMS message to a company directory application 109.

The privacy gateway 102 may receive the SMS message from the mobile device 104 which is identified by a first identifier, e.g. the MSISDN of the mobile device 104. The privacy gateway 102 will translate the MSISDN to a second identifier, e.g. 0001, for the mobile device 104 and transmit the SMS message to the application 109 so that the application can provide the service they have been requested to provide by the user 103. As the application 109 only receives the second identifier 0001 and the application 109 uses this second identifier 0001 to identify the mobile device 104 then the application 109 cannot communicate directly with the mobile device 104 and the application 109 does not know any information relating to, or be able to identify, the user 103. Accordingly, the privacy gateway 102 maintains the user's 103 privacy and security when the user 103 via their mobile 104 transmits communication messages to the application 109.

If the location data of the mobile device 104 is not included in the SMS message from the mobile device 104 then the privacy gateway 102 may request the mobile operator 107 of the user 103 to provide location data of the mobile device 104. The privacy gateway 102 will use the first identifier, e.g. the MSISDN, to identify the mobile device 104 to the mobile operator 107. The mobile operator will respond to the privacy gateway with the location data of the mobile device 104 using the first identifier to identify the mobile device 104 to the privacy gateway 102. the privacy gateway 102 may then include the location data in the SMS message that is to be transmitted to the application using the second identifier.

In the case that the application 109 needs to transmit communication messages to the mobile device 104 of the user 103 then the application 109 will transmit the communication message to the privacy gateway 102 identifying the mobile device 104 by the second identifier.

The application 109 may wish to transmit a communication message either in response to a received communication message from the mobile device 104 (via the privacy gateway 102) or the application 109 may wish to independently transmit a communication message to the mobile device of the user 103.

In the case that the communication from the application 109 to the mobile device then the privacy gateway 102, on receiving the communication message from the application 109, may proceed to translate the received second identifier, e.g. 0001, to the first identifier, e.g. the MSISDN of the mobile device 104. Once the first identifier has been identified by the privacy gateway 102 then the privacy gateway 102 may determine whether communication between the application 109 and the mobile device 104 is enabled or disabled based on the user control settings and/or the operator control settings. If the communication is enabled then the first identifier is used to transmit the communication message to the mobile device 104 of the user 103. Thus, the user's privacy and security is maintained as the application 109 only has knowledge of the second identifier which it uses to identify the mobile device 104 to the privacy gateway 102. As such, the application 109 is unable to communicate directly with the mobile device 104. Furthermore, as the user control settings and/or the operator control settings indicate whether the application is enabled to communicate with the mobile device 104 of the user 103 then communications from the application 109 may be blocked in an efficient manner without the need for the user 103 to interact directly with the application 109 to stop communication messages.

As described hereinabove, a company directory application 109 may receive, via the privacy gateway 102, an SMS message from a mobile device 104 of a user 103 requesting details on pizza delivery companies in the area of the location of the mobile device 104. In this example, the mobile device 104 will be identified to the application 109 via the second identifier, e.g. 0001. The application 109 will determine a list of pizza delivery companies in the area of the mobile device 104 and transmit a communication message, e.g. SMS message, containing the information to the privacy gateway 102 and identifying the mobile device 104 by the second identifier 0001. The privacy gateway 102 will translate the second identifier 0001 to the first identifier the MSISDN of the mobile device 104. Using the MSISDN the privacy gateway transmits the SMS message to the mobile device 104 of the user 103.

The application 109 may wish to independently transmit communication messages to one or more user's 103, 105 either in an impromptu manner or based on parameters relating to the user 103, 105 or the user's mobile device 104, 106. For example, the application 109 may wish to transmit a communication message to a particular mobile device 104 if the mobile device 104 enters a particular location area.

In this case, the application 109 may transmit a request message to the privacy gateway 102 identifying the mobile device 104 with the second identifier. If the communication from the application 109, 110 is dependent or based on, for example, parameters relating to the user 103 then the request message may request that the privacy gateway 102 inform the application once a parameter specified by the application 109 is fulfilled. Or the application 109 may include the communication message that they wish to transmit to the mobile device 104 when the parameter specified in the request message is fulfilled.

For example, the request message may specify that the application 109 should be informed once the mobile device 104, identified by the second identifier corresponding to the mobile device 104, is within a particular location. The privacy gateway 102 may translate the second identifier to the first identifier for the mobile device 104, e.g. the MSISDN of the mobile device. The privacy gateway 102 may determine whether communication from the application 109 to the mobile device 104 is enabled based on the user control settings and/or the operator control settings. If communication is enabled then the privacy gateway 102 may transmit a request message to the relevant mobile operator 107 for mobile device 104 requesting that it is informed once the mobile device 104, identified by the first identifier, is within a particular location.

Once the mobile device 104 enters the specified location then the mobile operator 107 informs the privacy gateway 102 which may inform the application 109, using the second identifier to identify the mobile device 104, so that the application 109, 110 can act on the information. Or the privacy gateway 102 may transmit a communication message to the mobile device 104 which was included in the request message from the application 109.

For example, the application 109 may be provided by an airline company. The application 109 may request to be informed when a mobile device 104 of user 103 enters within, for example, 5 miles of the airport so that the airline application 109 may automatically check-in the user 103 for their flight and transmit a confirmation message to the mobile device 104 of the user 103. The application 109 may transmit a request message to the privacy gateway 102 identifying the mobile device 104 via its second identifier. The privacy gateway 102 translates the second identifier to the first identifier and, if it is determined the communication is enabled, request the mobile operator 107 of the user 103 to inform the privacy gateway 102 of when the mobile device 104 enters within 5 miles of the airport. The privacy gateway 102 will use the first identifier, e.g. the MSISDN, of the mobile device 104 in the request message to enable the mobile operator 107 to identify the mobile device 104 in their network. The privacy gateway 102 may receive a response message from the mobile operator 107 when the mobile device 104 is within 5 miles of the airport using the first identifier to identify the mobile device 104 to the privacy gateway 102. The privacy gateway will translate the first identifier to the second identifier of the mobile device 104 and transmit a response to the application 109 informing it that the mobile device 104 meets its criteria or parameters. The application 109 based on this response will check-in the user 103 to their flight and transmit a confirmation message, via the privacy gateway 102, to the mobile device 104 of the user 103.

In another case, the application 109,110, may wish to transmit a communication message to several mobile devices 104, 106 either in an impromptu manner or based on particular parameters, for example, where those mobile devices 104, 106 are in a particular location area, the mobile devices 104, 106 belong to user's 103, 105 that are of a particular age, and so on. The application 109 may, in an example, request the second identifiers for all mobile devices 104, 106 that belong to user's 103, 105 which are over the age of 21. The privacy gateway 102 may request from the mobile operators 107, 108 a list of mobile devices 104, 106 that belong to user's 103, 105 that are over 21 years of age. The mobile operators 107, 108 may return a list of mobile devices 104, 106 identified by the first identifier, e.g. MSISDN of each mobile device 104, 106. The privacy gateway 102 may translate the list of first identifiers to second identifiers for each mobile device 104, 106 and determine if communication between each of the mobile devices 104, 106 is enabled with the application 109. If they are enabled then the privacy gateway 102 will provide the list of second identifiers to the application 109.

As will be appreciated, the parameters used in the above examples could be any parameter about a user 103, 105 or the mobile devices 104, 106 that may be stored or maintained by the privacy gateway 102 and/or the mobile operators 107, 108.

Accordingly, many of the embodiments enable the privacy of a user to be maintained when communicating with applications. The privacy is maintained by using a first identifier for communication between the privacy gateway and the mobile device of a user, and between the privacy gateway and the mobile operators. The second identifier is used for communication between the privacy gateway and the applications where the applications are unable to determine the real identity of the user or the mobile device of the user from the second identifier. The first identifier and the second identifier for each mobile device may be maintained by the privacy gateway which is trusted by the user and by the mobile operators.

While embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method for operating a gateway comprising:
receiving communications from a mobile device of a user;
receiving communications from an application;
controlling communications between a mobile device of a user and an application wherein said mobile device is identified by a first identifier for communications between said gateway and said mobile device and said mobile device is identified by a second identifier for communications between said gateway and said application;
translating between said first identifier and said second identifier; and
determining whether said communications between said mobile device and said application are enabled or disabled.

2. The method as claimed in claim 1 further comprising:
transmitting said communications to said mobile device or to said application if said communications between said mobile device and said application are enabled.

3. The method as claimed in claim 1 further comprising:
receiving user control settings relating to said mobile device;
storing said user control settings relating to said mobile device; and
wherein said step of determining whether said communications are enabled or disabled is based on said user control settings.

4. The method as claimed in claim 1 further comprising:
receiving operator control settings relating to a mobile operator;
storing said operator control settings relating to said mobile operator; and
wherein said step of determining whether said communications are enabled or disabled is based on said mobile operator control settings.

5. The method as claimed in claim 1 further comprising:
receiving communications from a mobile operator;
controlling communications between said application and said mobile operator wherein said mobile device is identified by said first identifier for communications between said gateway and said mobile operator; and
determining whether said communications between said application and said mobile operator are enabled or disabled.

6. A gateway comprising:
a first input adapted to receive communication from a mobile device of a user;
a first output adapted to transmit communication to said mobile device of said user;
a second input adapted to receive communication from an application;
a second output adapted to transmit communication to said application;
a first processor adapted to control communications between said mobile device and said application wherein said mobile device is identified by a first identifier for communications between said gateway and said mobile device and said mobile device is identified by a second identifier for communications between said gateway and said application;
a second processor adapted to translate between said first identifier and said second identifier on request of said first processor; and
a third processor adapted to determine whether said communications between said mobile device and said application are enabled or disabled on request of said first processor.

7. The gateway as claimed in claim 6 in which said first processor is further adapted to initiate transmission of said communications to said mobile device or to said application if said third processor determines said communications between said mobile device and said application are enabled.

8. The gateway as claimed in claim 6 further comprising:
a third input adapted to receive user control settings relating to said mobile device;
a fourth processor adapted to store said user control settings relating to said mobile device; and
wherein said third processor is further adapted to determine whether said communications are enabled or disabled based on said stored user control settings.

9. The gateway as claimed in claim 6 further comprising:
a fourth input adapted to receive mobile operator control settings relating to a mobile operator;
a fifth processor adapted to store said mobile operator control settings relating to said mobile operator; and
wherein said third processor is further adapted to determine whether said communications are enabled or disabled based on said stored mobile operator control settings.

10. The gateway as claimed in claim 6 further comprising:
a fifth input adapted to receive communication from a mobile operator;
a third output adapted to transmit communication to said mobile operator;
wherein said first processor is further adapted to control communications between said application and said mobile operator wherein said mobile device is identified by said first identifier for communications between said gateway and said mobile operator; and
wherein said third processor is further adapted to determine whether said communications between said application and said mobile operator are enabled or disabled on request of said first processor.

11. A computer program product comprising computer readable executable code for:
receiving communications from a mobile device of a user;
receiving communications from an application;
controlling communications between a mobile device of a user and an application wherein said mobile device is identified by a first identifier for communications between said gateway and said mobile device and said mobile device is identified by a second identifier for communications between said gateway and said application;
translating between said first identifier and said second identifier; and
determining whether said communications between said mobile device and said application are enabled or disabled.
